(19) United States
(12) Patent Application Publication
(10) Pub. No.: US 2026/0192512 A1
(43) Pub. Date: Jul. 9, 2026

(54) PHOTOSENSITIVE RESIN AND ITS METHOD FOR CLOSED-LOOP RECYCLING AND CIRCULAR 3D PRINTING

(71) Applicant: ZHEJIANG UNIVERSITY, Hangzhou (CN)

(72) Inventors: NING ZHENG, HANGZHOU (CN); TAO XIE, HANGZHOU (CN); BO YANG, HANGZHOU (CN); TIANTIAN NI, HANGZHOU (CN); CHENG LIU, HANGZHOU (CN); CHUAN YAO, HANGZHOU (CN)

(21) Appl. No.: 19/083,267

(22) Filed: Mar. 18, 2025

(30) Foreign Application Priority Data
Jan. 8, 2025 (CN) 2025100296282

(51) Int. Cl. B29C 64/129; B29K 81/00; C08J 11/10

(52) U.S. Cl. CPC B29C 64/129; C08J 11/10; B29K 2081/00; C08J 2341/00

(57) ABSTRACT

The present invention discloses a photosensitive resin, which includes a precursor containing active functional groups, a precursor containing thiol groups, and a light-activated catalyst. The active functional groups are selected from aldehyde groups, carbonyl groups, or hindered unsaturated double bonds. The present invention also discloses a method for closed-loop recycling and circular 3D printing of the photosensitive resin, which includes the following steps: the photosensitive resin is irradiated by the light source of a photopolymerization 3D printing device to obtain a 3D printed product; the 3D printed product to be recycled is dissolved, and after dissolution, depolymerization occurs to generate oligomers or monomers with terminal groups of thiol and active functional groups. A neutralizing reagent is then added to form the recycling system; the light-activated catalyst is reintroduced into the recycling system, and a new photosensitive resin is prepared for circular 3D printing. This photosensitive resin can achieve closed-loop recycling and multiple cycles of photopolymerization 3D printing, with mild recycling conditions and complete resource utilization of waste.

### TECHNICAL FIELD

The present invention relates to the field of photocurable 3D photosensitive resins, and more particularly to a photosensitive resin and its method for closed-loop recycling and circular 3D printing.

### BACKGROUND TECHNOLOGY

3D printing technology, as an additive manufacturing method, has garnered significant attention and widespread adoption in global manufacturing due to its unique flexibility, customization potential, and multi-degree-of-freedom capabilities. Among the various materials used, photopolymer resins play a critical role in numerous 3D printing technologies, including Stereolithography (SLA), Digital Light Processing (DLP), and Liquid Crystal Display (LCD). These resins typically consist of monomers containing photoreactive groups, such as acrylate or epoxy, along with photoinitiators. Upon exposure to a light source (usually ultraviolet or visible light), the photoinitiator is activated, initiating the free radical or cationic polymerization of the monomers to form a cross-linked network. In addition to their application in 3D printing, these resins are also used in fields like photolithography, coatings, and adhesives. However, once polymerized, photopolymer resins typically form a network backbone composed of carbon-carbon single bonds or carbon-oxygen single bonds. This structure is highly stable, resulting in a three-dimensional cross-linked network that cannot undergo depolymerization. Consequently, these resins cannot be recycled into a precursor liquid state suitable for re-polymerization. As 3D printing technology continues to gain traction as a next-generation manufacturing tool, the development of resin materials that enable closed-loop recycling and circular printing has become a critical focus and challenge in the pursuit of sustainability.

By introducing dynamic covalent bonds into the traditional acrylate resin system, it is possible to trigger depolymerization of the 3D printed network, thereby achieving a certain degree of chemical recycling of the material. To enable circular printing, existing approaches involve using recycled material as a filler, redistributing the recycled material into a new photopolymer resin, or recovering part of the material through depolymerization of dynamic ester bonds or hindered urea bonds, and then re-grafting acrylate groups for reprinting (e.g., in papers such as Repeatedly recyclable 3D printing catalyst-free dynamic thermosetting photopolymers, Recyclable photoresins for light-mediated additive manufacturing towards loop 3D printing). In the above systems, when achieving circular printing, a large amount of new photoreactive monomers must be introduced, leading to issues such as low recycling efficiency (with recycled materials accounting for less than 25% of the new printing material) and changes in the precursor liquid's properties (e.g., increased viscosity).

### SUMMARY OF THE INVENTION

The object of the present invention is to provide a photosensitive resin and a method for closed-loop recycling and circular 3D printing thereof. This photosensitive resin enables closed-loop recycling and multiple cycles of photocurable 3D printing.

The present invention provides the following technical solutions:

A photosensitive resin, wherein the photosensitive resin comprises a precursor containing active functional groups, a precursor containing thiol groups, and a photoactivated catalyst. The active functional groups are selected from aldehyde groups, carbonyl groups, or sterically hindered unsaturated double bonds. The precursor containing active functional groups can be a monomer or an oligomer, and the precursor containing thiol groups can also be a monomer or an oligomer.

The precursors in the photosensitive resin provided by the present invention include monomers and/or oligomers with thiol groups and aldehyde groups, carbonyl groups, or sterically hindered unsaturated double bonds. By adjusting the structure and composition of the oligomers, the mechanical properties of the material can be effectively tuned to meet the needs of various application scenarios.

The photosensitive resin provided by the present invention, upon exposure to the light source of a photocuring 3D printing device, generates a highly efficient catalyst, enabling rapid resin polymerization to produce 3D printed products.

Preferably, the aldehyde group-containing precursor includes, but is not limited to, vanillin, 4-hydroxybenzaldehyde, p-anisaldehyde, p-tertbutyl benzaldehyde, 4-cyanobenzaldehyde, 3-hydroxybenzaldehyde, benzaldehyde, the two-arm or multi-arm aldehydes derived from vanillin, 2-furaldehyde (furfural), 5-methylfurfural, 2-thiophenecarboxaldehyde, 5-methyl-2-thiophenecarboxaldehyde and one or more of the aldehyde-containing oligomers. A part of the structural formula is as follows:

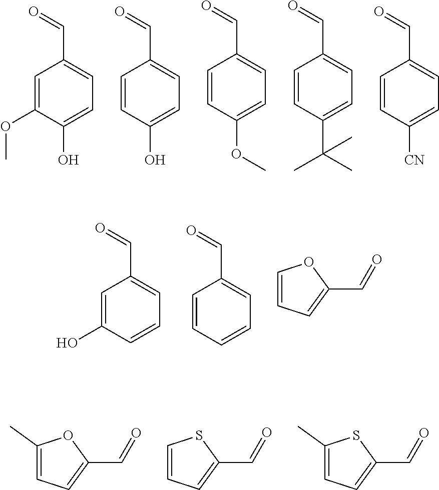

Preferably, the carbonyl group-containing precursor includes, but is not limited to 2,5-octanedione, spiro[5.5]undecane-3,9-dione, 2,7-dimethyloctane-3,6-dione, 2,15-hexadecanedione, 4,5-octanedione, 3-ethylpentane-2,4-dione, 1,3-diphenylpropanetrione, 1,3,5-tribromo-1,3,5-thiazinane-2,4,6-trione, 1,3-dibenzoylacetone, 2,3,5-hexanetrione, 2,3,5-heptanetrione and one or more types of ketone-containing oligomers. A part of the structural formula is as follows:

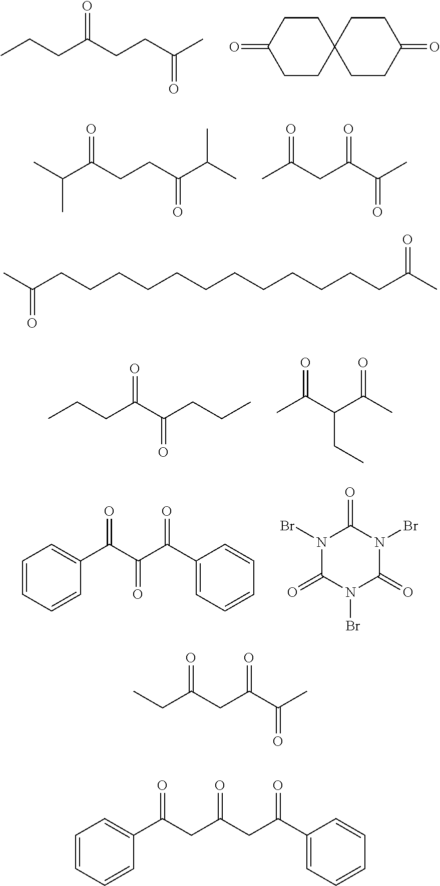

Preferably, the hindered unsaturated double bond precursor mentioned includes, but is not limited to, diisopropylidene oxide, 5-methylhexa-1,4-diene-3-one, neridienone B, 2,6-dimethyl-2,5,7-octatrien-4-one, 2,6-dimethyl-2,5-octadien-4-one, dimethylphenyl ketone, or one or more types of oligomers with hindered unsaturated double bonds. A part of the structural formula is as follows:

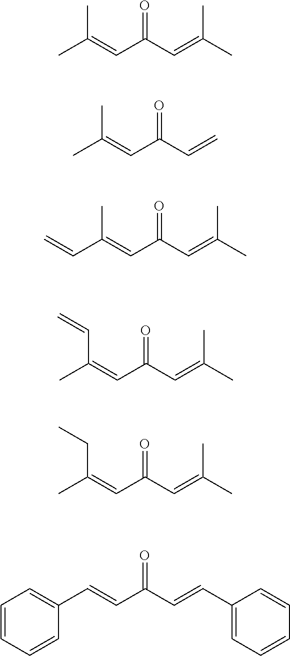

Preferably, the thiol-containing precursor includes, but is not limited to, 2,2-(1,2-ethanediyldioxy)bis(ethanethiol), 4,4′-dithiol-stilbene, 1,11-undecanedithiol, dithiothreitol, 1,16-hexadecanedithiol, hexa (ethylene glycol)disulfide1,6-hexyldithiol, 2,3-pentanedithiol, 3,7-dithia-1,9-nonanedithiol, bis(3-mercaptopropionic acid)ethylene glycol, 2-ethyl-2-(mercaptomethyl)-1,3-propanedithiol, pentaerythritol tetrakis(3-mercaptoacetate), pentaerythritol tetra(3-mercaptopropionate), tetrakis (3-mercaptopropionic acid) tetraester or one or more types of oligomers with thiol as the terminal group.

Preferably, the light-activated catalyst is selected from light acid-producing or light base-producing catalysts, with a light excitation wavelength ranging from 200 nm to 800 nm.

More preferably, the photo-acid generator includes, but is not limited to, one or more of aromatic diazonium salts, diaryliodonium salts, triarylsulfonium salts, dialkylformylmethylsulfonium salts, or ferrocene-based compounds.

More preferably, the photo-base generator includes, but is not limited to, one or more of cobalt amine complexes, benzoyl-based photo-base generators, benzamide-based photo-base generators, quaternary ammonium salts containing an aromatic ketone structure, or triarylmethanol compounds.

Preferably, the photosensitive resin includes the light absorber, the light absorber includes eosin Y, methyl red, Sudan red, Sudan black B, phthalocyanine red, phthalocyanine blue, auramine O, and the like.

The present invention also provides a method for a closed-loop recycling and circular 3D printing of photosensitive resin, comprising the following steps:
(1) irradiating the above-mentioned photosensitive resin with a light source in a photopolymerization 3D printing device to obtain a 3D printed product;
(2) dissolving the 3D printed product to be recycled, and after dissolution, depolymerizing the dissolved material to generate oligomers or/and monomers with terminal groups of thiol and active functional groups, then adding a neutralizing reagent to form the recycling system;
(3) reintroducing a light-activated catalyst into the recycling system, and formulating a new photosensitive resin for circular 3D printing.

Unlike traditional photopolymerization 3D printing methods, which rely on chain polymerization mechanisms such as free-radical or cationic polymerization, the present invention employs a light-activated catalyst to catalyze step-growth polymerization as the printing mechanism, using dynamic thiol-ether bonds as the fundamental building units. Under mild conditions, the dynamic thiol-ether bonds can depolymerize into monomers or/and oligomers containing active groups. Consequently, the present invention achieves minimal or no resin consumption during the circular printing process, thereby enabling the complete resource utilization of waste. This not only offers sustainability in terms of environmental protection but also significantly reduces the cost of 3D photosensitive resin through recycling.

Preferably, the photocuring 3D printing technology includes, but is not limited to, Stereolithography (SLA), Digital Light Processing (DLP), and Liquid Crystal Display (LCD).

1. In step (2), the neutralizing reagent includes acidic reagents and basic reagents. The acidic agents include, but are not limited to, hydrochloric acid, sulfuric acid, nitric acid, phosphoric acid, acetic acid, carbonic acid, hydrocyanic acid, boric acid, citric acid, aluminum chloride, ferric chloride, zinc chloride, hexafluoroantimonic acid, boron trifluoride, boron trichloride, phosphorus pentachloride, antimony pentafluoride, triarylphosphonium salts, and diaryliodonium salts. The basic agents include, but are not limited to, sodium bicarbonate, sodium carbonate, potassium carbonate, sodium acetate, sodium hydroxide, potassium hydroxide, methylamine, ethylamine, dimethylamine, trimethylamine, triethylamine, aniline, pyridine, pyrrole, imidazole, morpholine, piperidine, guanidine, 1,5,7-triazabicyclo[4.4.0]dec-5-ene, 1,8-diazabicyclo[5.4.0]undec-7-ene or 7-methyl-1,5,7-triazabicyclo[4.4.0]dec-5-ene.

2. In step (2), the 3D printed product to be recycled undergoes depolymerization under the action of a depolymerization catalyst. The light-activated catalyst remaining in the 3D printed product to be recycled directly acts as the depolymerization catalyst, or an additional acidic reagent or basic reagent is added simultaneously to function as the depolymerization catalyst for the depolymerization process. The acidic reagent is selected from one or more of hydrochloric acid, sulfuric acid, nitric acid, phosphoric acid, acetic acid, carbonic acid, hydrocyanic acid, boric acid, citric acid, aluminum chloride, ferric chloride, zinc chloride, hexafluoroantimonic acid, boron trifluoride, boron trichloride, phosphorus pentachloride, antimony pentafluoride, triarylphosphonium salts, and diaryliodonium salts. The basic reagent is selected from one or more of sodium bicarbonate, sodium carbonate, potassium carbonate, sodium acetate, sodium hydroxide, potassium hydroxide, methylamine, ethylamine, dimethylamine, trimethylamine, triethylamine, aniline, pyridine, pyrrole, imidazole, morpholine, piperidine, guanidine, 1,5,7-triazabicyclo[4.4.0]dec-5-ene, 1,8-diazabicyclo[5.4.0]undec-7-ene or 7-methyl-1,5,7-triazabicyclo[4.4.0]dec-5-ene. The amount of the depolymerization catalyst is 0.01% to 50% by weight of the photosensitive resin.

In step (2), a solvent is added to the 3D printed product to be recycled for dissolution. The solvent includes, but is not limited to, one or more of water, formamide, N,N′-dimethylformamide, N,N′-dimethylacetamide, dimethyl sulfoxide, acetonitrile, hexamethylphosphoramide, alcohol, pyridine, furan, tetrahydrofuran, 2-methyltetrahydrofuran, chloroform, and toluene. The amount of solvent used during the depolymerization process is 0.1 to 100 times the weight of the photosensitive resin.

More preferably, the solvent can be separated through methods such as reduced pressure distillation, absorption, condensation, adsorption, or membrane separation, allowing for the recycling of the solvent.

The depolymerization reaction temperature ranges from 25° C. to 200° C.; the reaction duration ranges from 1 minute to 50 hours.

It should be noted that the inherent moisture in the material or additional moisture can react with the dynamic thiol-ether bonds in the polymer, thereby generating oligomers and monomers containing active functional groups. The depolymerization catalyst can effectively promote this reaction process.

This method is simple to operate, has a short reaction time, and allows for easy solvent recovery. The recycled products are fully reused, offering good economic benefits and social value.

Further preferably, taking polydithioacetal as an example, dithioacetal bonds can depolymerize under acid-catalyzed conditions, resulting in the formation of aldehyde and thiol groups after the reaction (as shown in Reaction Equation I).

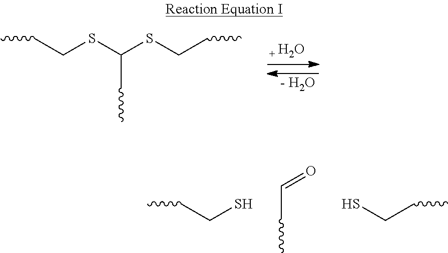

Preferably, the recycled resin consists of oligomers and monomers, with the characteristic functional groups on the terminal ends including aldehyde groups, carbonyl groups, or hindered unsaturated double bonds and thiol groups. The topology of the oligomer can be linear, branched, or hyperbranched macromolecules.

Further preferably, the proportion of the recycled oligomers and monomers in the new photosensitive resin is 90% to 100%.

The photosensitive resin provided by the present invention is capable of undergoing multiple closed-loop recycling and continuous 3D printing using the method described above. Preferably, the number of closed-loop recycling and 3D printing cycles ranges from 1 to 10 times.

Compared with the prior art, the beneficial effects of the present invention are as follows:

(1) The photosensitive resin obtained from the recycling process of the present invention can be directly used for printing without adding additional monomers, enabling multiple cycles of photopolymerization 3D printing. It has the advantages of mild recycling conditions, a simple recycling path, and complete resource utilization of waste. This solves the problem that photosensitive resins in the prior art cannot achieve fully closed-loop recycling and complete circular printing.

(2) Unlike conventional free-radical or cationic chain polymerization, the photosensitive resin provided by the present invention uses photocatalytic step-growth polymerization as its photopolymerization mechanism, effectively solving the problem of closed-loop recycling that is difficult to achieve with traditional 3D printing materials.

### BRIEF DESCRIPTION OF THE DRAWINGS

FIG. 1 is a schematic diagram of the recycling process in Example 1.

FIG. 2 shows the product obtained through 3D printing in Example 1.

### DETAILED EMBODIMENTS

The following examples are provided to describe the present invention in further detail. It should be noted that the embodiments described below are intended to facilitate understanding of the present invention and do not impose any limitations.

### Example 1 (Rigid Polydithioacetal Polymer)

### Raw Materials:

Vanillin: purchased from Macklin Company. 2,2-(1,2-ethylene dioxy)bis(ethanethiol) and Tetrakis(3-mercaptopropionate) pentaerythritol ester: purchased from TCI Company. Bis[(4-diphenylthiophenyl)sulfide]-bis-hexafluoroantimonate (PAG6976): purchased from Alibaba. Sodium bicarbonate and Tetrahydrofuran (THF): purchased from Sinopharm Company. Deionized water: purchased from Wahaha Company.

### 3D Printing:

Vanillin, 2,2-(1,2-ethylene dioxy)bis(ethanethiol), and tetrakis(3-mercaptopropionate) pentaerythritol ester were mixed at a molar ratio of 1.4:0.6:0.4. Subsequently, 3 wt % of PAG6976 was added to the mixture, resulting in a colorless and transparent resin. The resin was poured into an SLA 3D printer, where the laser intensity was set to 300 mW/cm², the printing speed to 500 mm/s, and the layer thickness to 200 μm. After printing, the product was subjected to heat treatment in a vacuum oven at 70° C. for 24 hours, producing a yellow, transparent 3D-printed object (As shown in FIG. 2). The mechanical properties of the material were tested using a universal material testing machine. The material exhibited a modulus of 141 MPa and an elongation at break of 682%.

### Recycling and Reprinting:

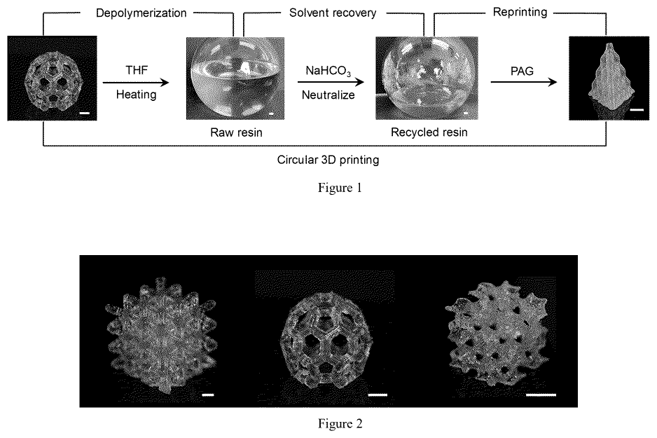

As shown in FIG. 1, the 3D printed product, water, and tetrahydrofuran (THF) were added to a flask in a mass ratio of 1:0.02:4. The mixture was heated to 80° C. and maintained for 120 minutes until the polymer was fully dissolved, resulting in a transparent orange solution. The residual light acid catalyst acts as the depolymerization catalyst. The solution was then treated with an excess of neutralizing agent, sodium bicarbonate, and stirred at room temperature for 5 minutes to neutralize the remaining acid in the system. The excess sodium bicarbonate was removed by filtration, and tetrahydrofuran was evaporated off using a rotary evaporator, ultimately obtaining liquid resin. Next, 3 wt % PAG6976 and 10 wt % 2-butoxyethanol solvent were added to the recycled resin to produce a printable resin. The 3D printing and post-processing were carried out as described in the previous method. The mechanical properties of the resulting product were tested using a universal materials testing machine, with a modulus of 143 MPa and a fracture elongation of 539%.

### Example 2 (Crystalline Polydithioacetal Polymer)

### Raw Materials:

Vanillin: purchased from Macklin Company. 2,2-(1,2-Ethylene dioxy)bis(ethanethiol), Tetrakis(3-mercaptopropionate) pentaerythritol ester, and Dibutyltin dilaurate: purchased from TCI Company. Bis[(4-diphenylthiophenyl)sulfide]-bis-hexafluoroantimonate (PAG6976): purchased from Alibaba Company. Sodium bicarbonate, Toluene, Methanol, and 2-Methyltetrahydrofuran: purchased from Sinopharm Company. Deionized water: purchased from Wahaha Company. ε-Caprolactone, Ethylene glycol, Triethylamine, and 2-Isocyanatoethyl methacrylate: purchased from Aladdin Company.

### Synthesis of Thiol-Terminated Polycaprolactone Oligomers:

Synthesis of Polycaprolactone: ε-Caprolactone (50 g), ethylene glycol (0.48 g), and dibutyltin dilaurate (0.1 g, catalyst) were mixed and stirred at 120° C. under a nitrogen atmosphere for 8 hours. The product was dissolved in toluene (100 mL) and then precipitated in methanol. This dissolution-precipitation process was repeated three times to purify the product. The final product was vacuum-dried at room temperature for 24 hours.

Synthesis of Polycaprolactone Diacrylate: Polycaprolactone (30 g), 2-isocyanatoethyl methacrylate (1 g), and dibutyltin dilaurate (0.1 g, catalyst) were dissolved in toluene (15 mL). The mixture was stirred at 80° C. under a nitrogen atmosphere for 4 hours. The solution was precipitated in methanol, and the dissolution-precipitation process was repeated for purification. The final product was vacuum-dried at room temperature for 24 hours.

Final synthesis of Thiol-Terminated Polycaprolactone Oligomers: Polycaprolactone diacrylate (10 g), 2,2-(1,2-ethylene dioxy)bis(ethanethiol) (0.62 g), toluene (10 g), and triethylamine (0.2 g) were added to a round-bottom flask. The mixture was stirred at room temperature until completely dissolved. The mixture was then heated to 80° C. for 6 hours. The product was obtained by precipitating the solution in methanol and filtering.

### 3D Printing:

Vanillin (0.24 g), PTMP (0.19 g), thiol-terminated polycaprolactone oligomer (5.4 g), acetonitrile (2.7 g), and 1 wt % PAG were uniformly mixed until completely dissolved, forming a colorless and transparent resin. The resin was poured into an SLA 3D printer, where the laser intensity was set to 300 mW/cm², the printing speed to 500 mm/s, and the layer thickness to 200 μm. After printing, the product was heat-treated in a vacuum oven at 70° C. for 24 hours, resulting in a white crystalline 3D-printed product. The mechanical properties of the printed material were tested using a universal material testing machine. The material exhibited a modulus of 41.1 MPa and an elongation at break of 1250%.

### Recycling and Reprinting:

The 3D-printed product, 2 wt % water, and 2-methyltetrahydrofuran were added to a flask at a mass ratio of 1:0.02:4. The mixture was heated to 80° C. and maintained for 120 minutes until the polymer was fully dissolved, forming a transparent orange solution. The solution was treated with an excess of sodium bicarbonate and stirred at room temperature for 5 minutes to neutralize residual acid in the system. Excess sodium bicarbonate was removed by filtration, and 2-methyltetrahydrofuran was removed using a rotary evaporator, yielding a liquid resin. To the recovered resin, 3 wt % PAG6976 was added to prepare a reprintable resin. The 3D printing and post-processing steps were performed as described previously. The mechanical properties of the reprinted product were tested using a universal material testing machine. The material demonstrated a modulus of 39.7 MPa and an elongation at break of 1207%.

### Example 3 (Polydithioacetal Polymer, DLP Printing)

### Raw Materials:

Furfural: purchased from Aladdin Company. 2,2-(1,2-Ethylene dioxy)bis(ethanethiol) and Tetrakis(3-mercaptopropionate) pentaerythritol ester: purchased from TCI Company. H6-Isopropylbenzene ferrocene hexafluorophosphate (PAG261): purchased from Alibaba. Sodium bicarbonate and Tetrahydrofuran (THF): purchased from Sinopharm Company. Deionized water: purchased from Wahaha Company.

### 3D Printing:

Furfural, 2,2-(1,2-ethylene dioxy)bis(ethanethiol), and tetrakis(3-mercaptopropionate) pentaerythritol ester were mixed at a molar ratio of 1.4:0.6:0.4. Subsequently, 3 wt % PAG 261 was added to the mixture, resulting in a colorless and transparent resin. The resin was poured into a DLP 3D printer, where the light source intensity was set to 30 mW/cm² and the printing speed to 50 mm/s. The process produced a transparent 3D-printed product.

### Recycling and Reprinting:

The 3D-printed product, water, and tetrahydrofuran (THF) were added to a flask at a mass ratio of 1:0.02:4. The mixture was heated to 80° C. and maintained for 120 minutes until the polymer was fully dissolved, forming a transparent orange solution. The solution was then treated with an excess of sodium bicarbonate and stirred at room temperature for 5 minutes to neutralize any residual acid in the system. Excess sodium bicarbonate was removed by filtration, and THF was removed using a rotary evaporator, yielding a liquid resin. To the recovered resin, 3 wt % PAG 261 was added to prepare a re-photocurable resin. The DLP 3D printing process was repeated as described above, resulting in a successfully reprinted 3D product.

### Example 4 (Polydithioketone Polymer, Organic Solvent-Free Recycling)

### Raw Materials:

2,15-Hexadecanedione: purchased from Aladdin Company. 2,2-(1,2-Ethylene dioxy)bis(ethanethiol) and Tetrakis(3-mercaptopropionate) pentaerythritol ester: purchased from TCI Company. Bis[(4-diphenylthiophenyl)sulfide]-bis-hexafluoroantimonate (PAG6976): purchased from Alibaba Company. Sodium bicarbonate: purchased from Sinopharm Company. Deionized water: purchased from Wahaha Company.

### 3D Printing:

2,15-Hexadecanedione, 2,2-(1,2-ethylene dioxy)bis(ethanethiol), and tetrakis(3-mercaptopropionate) pentaerythritol ester were mixed at a molar ratio of 0.7:0.6:0.4. Then, 3 wt % PAG6976 was added to the mixture to obtain a transparent resin. The resin was poured into an SLA 3D printer, where the laser intensity was set to 300 mW/cm² and the printing speed to 500 mm/s. The process yielded a 3D-printed product.

### Recycling and Reprinting:

The 3D-printed product and water were added to a flask at a mass ratio of 1:0.05. The mixture was heated to 80° C. and maintained for 120 minutes until the polymer was fully dissolved, forming a transparent orange solution. The solution was treated with an excess of sodium bicarbonate and stirred at room temperature for 5 minutes to neutralize any residual acid. Excess sodium bicarbonate was removed by filtration, yielding a liquid resin. To the recovered resin, 3 wt % PAG6976 was added to prepare a reprintable resin. The SLA 3D printing process was repeated as described above, successfully producing a 3D-printed product.

### Example 5 (Polydithioketone Polymer, LCD Printing)

### Raw Materials:

2,5-Octanedione: purchased from Aladdin Company. 2,2-(1,2-Ethylene dioxy)bis(ethanethiol) and Tetrakis(3-mercaptopropionate) pentaerythritol ester: purchased from TCI Company. H6-Isopropylbenzene ferrocene hexafluorophosphate (PAG 261): purchased from Alibaba Company. Sodium bicarbonate and Tetrahydrofuran (THF): purchased from Sinopharm Company. Water: purchased from Wahaha Company.

### 3D Printing:

2,5-Octanedione, 2,2-(1,2-ethylene dioxy)bis(ethanethiol), and tetrakis(3-mercaptopropionate) pentaerythritol ester were mixed at a molar ratio of 0.7:0.6:0.4. Then, 3 wt % PAG261 was added to the mixture to obtain a transparent resin. The resin was poured into an LCD 3D printer, where the light source intensity was set to 30 mW/cm² and the printing speed to 50 mm/second. This process produced a transparent 3D-printed product.

### Recycling and Reprinting:

The photocured polymer, water, and tetrahydrofuran (THF) were added to a flask at a mass ratio of 1:0.02:4. The mixture was heated to 80° C. and maintained for 120 minutes until the polymer completely dissolved, forming a transparent orange solution. The solution was then treated with an excess of sodium bicarbonate and stirred at room temperature for 5 minutes to neutralize any residual acid. Excess sodium bicarbonate was removed by filtration, and THF was removed using a rotary evaporator, yielding a liquid resin. To the recovered resin, 3 wt % PAG261 was added to prepare a re-photocurable resin. The LCD 3D printing process was repeated as described above, successfully producing a reprinted 3D product.

### Example 6 (Polythiodiene Polymer)

### Raw Materials:

Diisopropylidene acetone, Sudan Red: purchased from Aladdin Company. 2,2-(1,2-Ethylene dioxy)bis(ethanethiol), Tetrakis(3-mercaptopropionate) pentaerythritol ester, Ketobuprofen, and 1,5,7-Triazabicyclo[4.4.0]dec-5-ene (TBD): purchased from TCI Company. Toluene and Acetic acid: purchased from Sinopharm Company.

### Preparation of Photo-Base Generator:

1,5,7-Triazabicyclo[4.4.0]dec-5-ene (TBD) was complexed with ketobuprofen to produce a photo-base generator. The detailed procedure is as follows: 0.200 g of TBD, 0.384 g of ketobuprofen, and 2.366 g of toluene were weighed. these materials were added into a brown glass bottle wrapped in aluminum foil to prevent light exposure (light protection is a critical step). The mixture at room temperature was stirred for 2 hours until the reaction was nearly complete. The resulting solution was stored in a light-protected environment.

### 3D Printing:

1.4 moles of diisopropylidene acetone, 0.6 moles of 2,2-(1,2-ethanediyl bis(oxy))bis(ethanethiol), and 0.4 moles of tetra(3-mercaptopropionic acid) pentaerythritol ester were thoroughly mixed, and then 3 wt % of a light base-producing catalyst and 0.1 wt % Sudan Red were added to obtain a transparent red resin. The resin was poured into an SLA 3D printer, with a laser intensity of 300 mW/cm² and a printing speed of 500 mm/s to obtain a 3D printed product.

### Recycling and Reprinting:

The 3D-printed product was heated to 80° C. and maintained for 120 minutes until the polymer transformed into a liquid state. Acetic acid was then added to neutralize the resin to a neutral pH. To the recovered resin, 3 wt % of the photo-base generator was added, producing a reprintable resin. The SLA 3D printing process was repeated as described above, successfully producing a reprinted 3D product.

### Example 7 (Multiple Circular Printing of Rigid Polydithioacetal Polymers)

### Raw Materials:

Vanillin: purchased from Macklin Company. 2,2-(1,2-Ethylene dioxy)bis(ethanethiol) and Tetrakis(3-mercaptopropionate) pentaerythritol ester: purchased from TCI Company. Bis[(4-diphenylthiophenyl)sulfide]-bis-hexafluoroantimonate (PAG6976): purchased from Alibaba Company. Sodium bicarbonate and Tetrahydrofuran (THF): purchased from Sinopharm Company. Deionized water: purchased from Wahaha Company.

### 3D Printing:

Vanillin, 2,2-(1,2-ethanediyl dioxy)bis(ethanethiol), and tetra(3-mercaptoacetic acid) pentaerythritol ester were mixed in a molar ratio of 1.4:0.6:0.4, and add 3 wt % PAG6976 to obtain a colorless transparent resin. The resin was poured into an SLA 3D printer, with a laser intensity of 300 mW/cm², a printing speed of 500 mm/s, and a layer thickness of 200 μm. After printing, the product was placed in a 70° C. vacuum oven for thermal treatment for 24 hours to obtain a yellow-transparent 3D printed product (as shown in FIGS. 2a and 2b). The mechanical properties were tested using a universal materials testing machine, with a modulus of 141 MPa and elongation at break of 682%.

### First Circular Printing:

The 3D printed product, water, and tetrahydrofuran (THF) were added to a flask in a mass ratio of 1:0.02:4. The mixture was heated to 80° C. and maintained for 120 minutes until the polymer was completely dissolved, resulting in a transparent orange solution. The solution was then treated with an excess of sodium bicarbonate and stirred at room temperature for 5 minutes to neutralize the remaining acid in the system. The excess sodium bicarbonate was removed by filtration, and tetrahydrofuran was removed using a rotary evaporator, ultimately obtaining liquid resin. Then, 3 wt % PAG6976 and 10 wt % 2-butoxyethanol solvent were added to the recycled resin to obtain a printable resin. The 3D printing and post-processing were carried out as described in the previous method. The mechanical properties of the resulting product were tested using a universal materials testing machine, with a modulus of 143 MPa and elongation at break of 539%.

### Second Circular Printing:

The 3D printed product, water, and tetrahydrofuran (THF) were added to a flask in a mass ratio of 1:0.02:4. The mixture was added to 80° C. and maintained for 120 minutes until the polymer was completely dissolved, resulting in a transparent orange solution. The solution was then treated with an excess of sodium bicarbonate and stirred at room temperature for 5 minutes to neutralize the remaining acid in the system. The excess sodium bicarbonate was removed by filtration, and tetrahydrofuran was removed using a rotary evaporator, ultimately obtaining liquid resin. Next, 3 wt % PAG6976 and 10 wt % 2-butoxyethanol solvent were added to the recycled resin to obtain a printable resin. The 3D printing and post-processing were carried out as described in the previous method. The mechanical properties of the resulting product were tested using a universal materials testing machine, with a modulus of 143 MPa and elongation at break of 757%.

### Third Circular Printing:

The 3D printed product, water, and tetrahydrofuran (THF) were added to a flask in a mass ratio of 1:0.02:4. The mixture was heated to 80° C. and maintain for 120 minutes until the polymer was completely dissolved, resulting in a transparent orange solution. The solution was then treated with an excess of sodium bicarbonate and stirred at room temperature for 5 minutes to neutralize the remaining acid in the system. The excess sodium bicarbonate was removed by filtration, and tetrahydrofuran was removed using a rotary evaporator, ultimately obtaining liquid resin. Next, 3 wt % PAG6976 and 10 wt % 2-butoxyethanol solvent were added to the recycled resin to obtain a printable resin. The 3D printing and post-processing were carried out as described in the previous method. The mechanical properties of the resulting product were tested using a universal materials testing machine, with a modulus of 153 MPa and elongation at break of 530%.

1: A photosensitive resin characterized by comprising a precursor containing active functional groups, a precursor containing thiol groups, and a photoactivated catalyst, wherein the active functional groups are selected from aldehyde groups, carbonyl groups, or sterically hindered unsaturated double bonds; the precursor containing active functional groups are either a monomer or an oligomer, while the precursor containing thiol groups are a monomer or an oligomer.

2: The photosensitive resin according to claim 1, characterized in that when the precursor containing active functional groups is an aldehyde-containing precursor, the aldehyde-containing precursor is selected from vanillin, 4-hydroxybenzaldehyde, p-anisaldehyde, p-tertbutyl benzaldehyde, 4-cyanobenzaldehyde, 3-hydroxybenzaldehyde, benzaldehyde, the two-arm or multi-arm aldehydes derived from vanillin, 2-furaldehyde, 5-methylfurfural, 2-thiophenecarboxaldehyde, 5-methyl-2-thiophenecarboxaldehyde and one or more of the aldehyde-containing oligomers;
when the precursor containing active functional groups is a carbonyl-containing precursor, the carbonyl-containing precursor is selected from 2,5-octanedione, spiro[5.5]undecane-3,9-dione, 2,7-dimethyloctane-3,6-dione, 2,15-hexadecanedione, 4,5-octanedione, 3-ethylpentane-2,4-dione, 1,3-diphenylpropanetrione, 1,3,5-tribromo-1,3,5-thiazinane-2,4,6-trione, 1,3-dibenzoylacetone, 2,3,5-hexanetrione, 2,3,5-heptanetrione and one or more types of ketone-containing oligomers;
when the precursor containing active functional groups is a precursor with sterically hindered unsaturated double bonds, the precursor with sterically hindered unsaturated double bonds is selected from diisopropylidene oxide, 5-methylhexa-1,4-diene-3-one, neridienone B, 2,6-dimethyl-2,5,7-octatrien-4-one, 2,6-dimethyl-2,5-octadien-4-one, dimethylphenyl ketone, or one or more types of oligomers with hindered unsaturated double bonds;
the thiol-containing precursor is selected from 2,2-(1,2-ethanediyldioxy)bis(ethanethiol), 4,4′-dithiol-stilbene, 1,11-undecanedithiol, dithiothreitol, 1,16-hexadecanedithiol, hexa (ethylene glycol)disulfide, 1,6-hexyldithiol, 2,3-pentanedithiol, 3,7-dithia-1,9-nonanedithiol, bis(3-mercaptopropionic acid)ethylene glycol, 2-ethyl-2-(mercaptomethyl)-1,3-propanedithiol, pentaerythritol tetrakis(3-mercaptoacetate), pentaerythritol tetra(3-mercaptopropionate), tetrakis (3-mercaptopropionic acid) tetraester or one or more types of oligomers with thiol as the terminal group.

3: The photosensitive resin according to claim 1, characterized in that the photoactivated catalyst is selected from photo-generated acid or photo-generated base, and the photoactivation wavelength of the photoactivated catalyst ranges from 200 nm to 800 nm, the photo-generated acid is selected from one or more aromatic diazonium salts, diaryliodonium salts, triarylsulfonium salts, dialkylformylmethylsulfonium salts, or ferrocene-based compounds, and the photo-generated base is selected from one or more of cobalt ammonia complexes, benzoyl-based photo-generated base, benzamide-based photo-base generators, quaternary ammonium salts containing an aromatic ketone structure, or triarylmethanol compounds.

4: The photosensitive resin according to claim 1, characterized in that the photosensitive resin comprises a light absorber.

5: A method for closed-loop recycling and circular 3D printing of a photosensitive resin, characterized in that the method comprises the following steps:
(1) obtaining a 3D printed product after irradiating the photosensitive resin described in claim 1 with a light source in a photocuring 3D printing device;
(2) dissolving a 3D printed product to be recycled, and after dissolution, depolymerizing the solution to generate oligomers and/or monomers with thiol and active functional group terminal groups, then adding a neutralizing agent to form a recycling system;
(3) reintroducing a photoactivated catalyst into the recycling system to formulate a new photosensitive resin for circular 3D printing.

6: The method for closed-loop recycling and circular 3D printing of a photosensitive resin according to claim 5, is characterized in that, in the step (2), the neutralizing agent is selected from acidic agents or basic agents, wherein the acidic agents are selected from one or more of hydrochloric acid, sulfuric acid, nitric acid, phosphoric acid, acetic acid, carbonic acid, hydrocyanic acid, boric acid, citric acid, aluminum chloride, ferric chloride, zinc chloride, hexafluoroantimonic acid, boron trifluoride, boron trichloride, phosphorus pentachloride, antimony pentafluoride, triarylphosphonium salts, and diaryliodonium salts; the basic agents are selected from one or more of sodium bicarbonate, sodium carbonate, potassium carbonate, sodium acetate, sodium hydroxide, potassium hydroxide, methylamine, ethylamine, dimethylamine, trimethylamine, triethylamine, aniline, pyridine, pyrrole, imidazole, morpholine, piperidine, guanidine, 1,5,7-triazabicyclo[4.4.0]dec-5-ene, 1,8-Diazabicyclo[5.4.0]undec-7-ene or 7-methyl-1,5,7-triazabicyclo[4.4.0]dec-5-ene.

7: The method for closed-loop recycling and circular 3D printing of a photosensitive resin according to claim 5, is characterized in that, in the step (2), the 3D printed product to be recycled undergoes depolymerization under the action of a depolymerization catalyst, the residual photoactivated catalyst in the 3D printed product directly acts as the depolymerization catalyst, or additional acidic or basic agents are simultaneously added as depolymerization catalysts, the acidic agents are selected from one or more of hydrochloric acid, sulfuric acid, nitric acid, phosphoric acid, acetic acid, carbonic acid, hydrocyanic acid, boric acid, citric acid, aluminum chloride, ferric chloride, zinc chloride, hexafluoroantimonic acid, boron trifluoride, boron trichloride, phosphorus pentachloride, antimony pentafluoride, triarylphosphonium salts, and diaryliodonium salts; the basic agents are selected from one or more of sodium bicarbonate, sodium carbonate, potassium carbonate, sodium acetate, sodium hydroxide, potassium hydroxide, methylamine, ethylamine, dimethylamine, trimethylamine, triethylamine, aniline, pyridine, pyrrole, imidazole, morpholine, piperidine, guanidine, 1,5,7-triazabicyclo[4.4.0]dec-5-ene, 1,8-Diazabicyclo[5.4.0]undec-7-ene or 7-methyl-1,5,7-triazabicyclo[4.4.0]dec-5-ene; the amount of the depolymerization catalyst is 0.01 to 50 wt % of the mass of the photosensitive resin.

8: The method for closed-loop recycling and circular 3D printing of a photosensitive resin according to claim 5, characterized in that, in the step (2), a solvent is added to the 3D printed product to be recycled for dissolution; the solvent is selected from one or more of water, formamide, N,N′-dimethylformamide, N,N′-dimethylacetamide, dimethyl sulfoxide, acetonitrile, hexamethylphosphoramide, alcohol, pyridine, furan, tetrahydrofuran, methyltetrahydrofuran, chloroform and toluene; the amount of the solvent is 0.1 to 100 times the mass of the photosensitive resin.

9: The method for closed-loop recycling and circular 3D printing of a photosensitive resin according to claim 5, is characterized in that, in the step (3), the recovered oligomers and/or monomers account for 90% to 100% of a new photosensitive resin.

10: The method for closed-loop recycling and circular 3D printing of a photosensitive resin according to claim 5, is characterized in that the number of closed-loop recycling and circular 3D printing cycles is 1 to 10 times.
